(19) United States
(12) Patent Application Publication
(10) Pub. No.: US 2017/0322414 A1
(43) Pub. Date: Nov. 9, 2017

(54) Optical waveguide using fresnel lenses

(71) Applicant: Fusao Ishii, Pittsburgh, PA (US)

(72) Inventor: Fusao Ishii, Pittsburgh, PA (US)

(21) Appl. No.: 14/999,458

(22) Filed: May 9, 2016

(51) Int. Cl. G02B 27/01; G02B 17/00; G02B 3/08

(52) U.S. Cl. CPC G02B 27/0101; G02B 17/006; G02B 3/08; G02B 2027/0125; G02B 2027/013; G02B 2027/012

(57) ABSTRACT

An optical waveguide for a see-through display system using Fresnel lenses is disclosed. This invention enables high efficiency of light utilization, wavelength independence, high resolution and very small form factor. This display system is suitable for head-up-display and wearable display.

### CROSS REFERENCE TO RELATED APPLICATIONS

This application is a Non-Provisional application from a previously filed Provisional Application, 62/178,467 filed on Apr. 10, 2015 and is a Patent in Continuation of PCT application, PCT/US2014/000153, filed on Jun. 27, 2014 which claims the Priority Dates of previously filed Provisional Applications 61/957,258 filed on Jun. 27, 2013, 61/958,491 filed on Jul. 29, 2013, 61/959,953 filed on Sep. 7, 2013, 61/966,519 filed on Feb. 25, 2014 and 61/995,664 on filed on Apr. 17, 2014.

### TECHNICAL FIELD

This invention relates to a see-through display for projecting an image through a thin waveguide using Fresnel lenses. This display works as a periscope with a thin waveguide combined with Fresnel lenses having reflective surfaces. This display is suitable for see-through head-up-displays for automobile and wearable displays.

### BACKGROUND ART

See-through displays get attention in recent years especially for head-up-displays and wearable displays after smart phones are well accepted by the market. See-through displays provide hands free operation as well as showing image in the distance same as regular sight. There are tremendous needs for see-through displays. See-through displays using hologram were proposed with some successful results. However in the past, see-through displays using hologram have not necessarily satisfied viewers, because they were often too low resolution, too low light utilization efficiency, not enough viewing angle and difficulty to eliminate unnecessary high order diffraction which ends up with ghost images. There are needs of optical system enabling light, small, bright, high resolution and see-through. This invention provides a new optical system which satisfies all of these needs using conventional display devices such as LCD, LCOS, OLED, Micromirror, and Laser Beam Scanner.

As shown in FIG. 1, Freedman discloses in U.S. Pat. No. 777,960 a head-up-display using Fresnel lenses to divert the direction of image reflection, but this does not reduce the size of display.

As shown in FIG. 2, Voloschenko et al. disclose in U.S. Pat. No. 7,031,067 a head-up-display built in a dashboard of a car. This does not reduce the size of display.

As shown in FIG. 3, Kasai et al. disclose in U.S. Pat. No. 7,460,286 an eye glass type display system that implements see-through capability with a holographic optical element. This system can reduce the size of display substantially. But this system requires hologram and the efficiency of light utilization is low and it is difficult achieve high resolution or large viewing angle.

As shown in FIG. 4, Mukawa et al. in SID 2008 Digest, ISSN/008-0966X/08/3901-0089, “A Full Color Eyewear Display using Holographic Planar Waveguides”, disclose an eye glass type display system that implements see-through capability with two holographic optical elements. This system can reduce the size of display substantially. But this system requires hologram and the efficiency of light utilization is low and it is difficult achieve high resolution or large viewing angle.

The above two inventions are using hologram to enable see-through capability. Hologram appears very smart and highly theoretical. However hologram often has critical problems, such as the requirement of too narrow band width of light wavelength, very low efficiency of light utilization of display device and often unnecessary high order diffractions. The efficiency is reported often below 20%. A see-through hologram optical system requires laser light source rather than LED to achieve high resolution and high power to achieve brightness because of low efficiency. Often, it requires some light shields to stop unnecessary zero order and/or high order diffractions. Therefore there is tremendous need for a see-through optics system enabling high efficiency, no or low dependency on wavelength, no ghost images and small form factor usable for head-up-display and near eye displays.

### SUMMARY OF THE INVENTION

It is an aspect of this invention to provide an optics to transfer an image of display into a very thin waveguide at substantially parallel direction (almost horizontal shift of image) with very low loss of light and without wavelength dependency using Fresnel mirror whose micro-ridges have arbitrary slopes of free-form surface (hereafter “Free-Form-Fresnel”). Note: free-from surface is a computer generated non-symmetric surface which differs from spherical and aspherical (not spherical but still having rotational symmetry).

Another aspect of this invention is to provide an optics enabling a see-through display with a very thin waveguide usable for head-up-display and wearable display without the wavelength dependency as hologram or DOE and without high loss of light using Free-Form-Fresnel mirror with the condition of total internal reflection (hereafter TIR).

Another aspect of this invention is to provide an optics for a see-through display with a very thin waveguide minimizing Astigmatic and Coma aberrations to achieve high resolution using lenses with free-form surfaces.

Another aspect of this invention is to provide an optics for a see-through display having a large eye-box using Free-From-Fresnel lenses.

Another aspect of this invention is to provide a manufacturing method to create arbitrary slopes of Fresnel micro-ridges having free-form surface.

### BRIEF DESCRIPTION OF THE DRAWINGS

FIG. 1 show an example of head-up-display with a reflecting screen having Fresnel lens, which was published as a US Patent This mirror changes the direction of reflection from a conventional mirror, but does not reduce the size of display system.

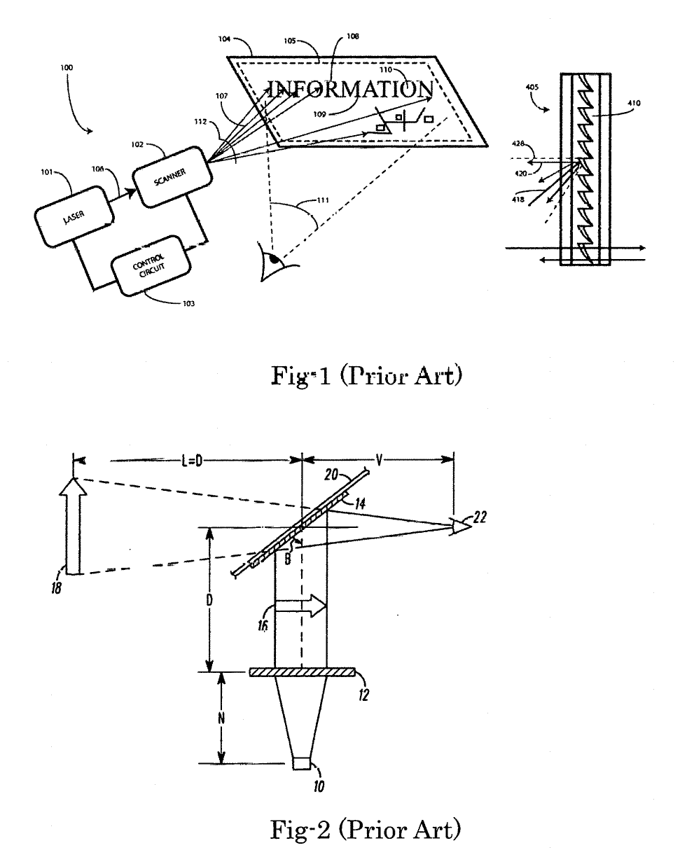

FIG. 2 shows another example of head-up-display which is buried in a dashboard, which requires a large space.

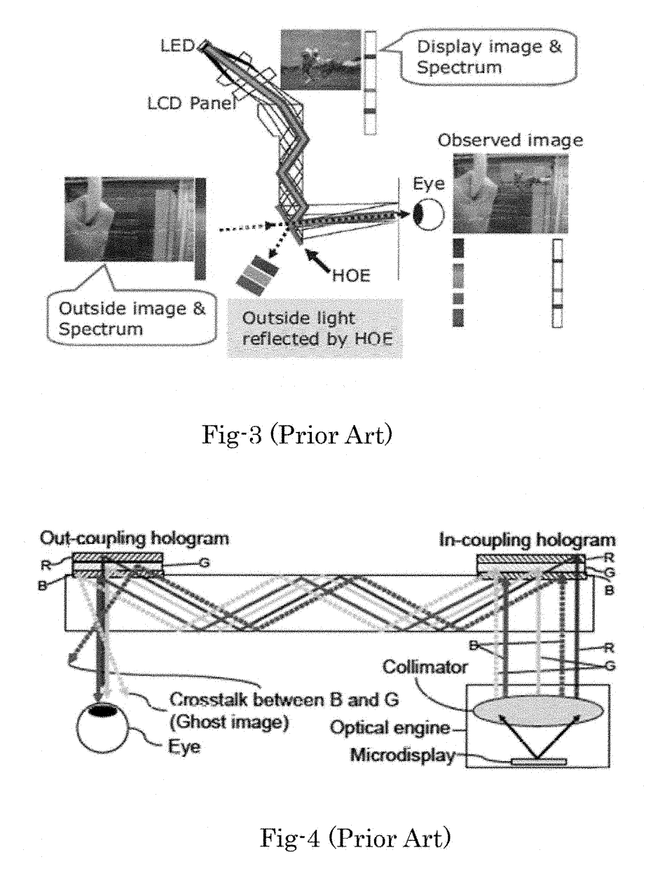

FIG. 3 is a cross sectional view of an image display system of prior art shown by Kasai in his published technical report related to U.S. Pat. No. 7,460,286. The left photo is a photo of the actual sample which successfully demonstrated see-though capability.

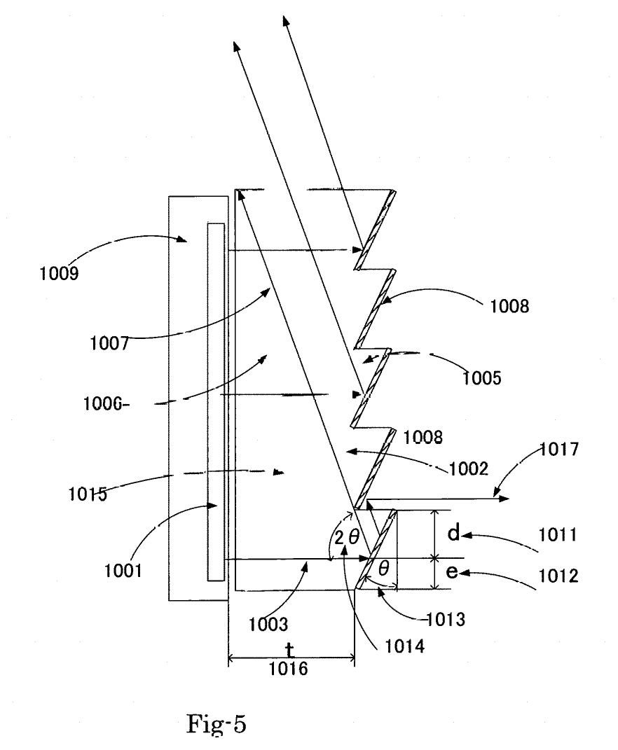

FIG. 4 is shown by Mukawa et al. in SID 2008 Digest, ISSN/008-0966X/08/3901-0089, “A Full Color Eyewear Display using Holographic Planar Waveguides”. A sample wearable display having a concept of FIG. 4 successfully demonstrated see-through capability.

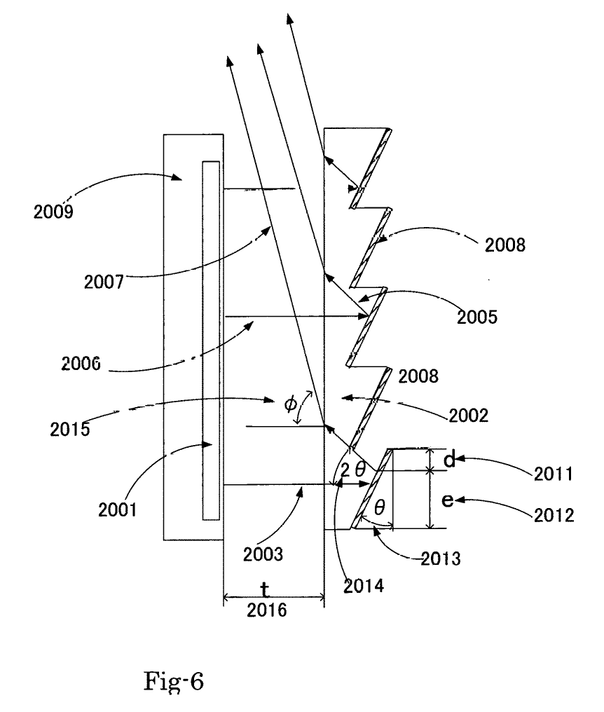

FIG. 5 illustrates an example of embodiment of this invention. 1001 is a display such as LCD. 1009 is a unit containing the display as a smart phone. 1003 is light from the display. 1015 is a Fresnel lens having mirrors 1008. 1012 marked “e” is the area where incoming light is utilized and reflected toward a waveguide. The light entering the area marked “d” 1011 is wasted and not utilized.

FIG. 6 illustrates another example of this invention. 2001 is a display and 2009 is a box containing the display as a smart phone. 2003 is light from the display. 2015 is an air gap between the display and a Fresnel lens (2002). 2012 marked “e” is the area where incoming light is utilized and reflected toward a waveguide. The light entering the area marked “d” 2011 is wasted and not utilized. This example has substantially smaller “d” than the previous example (FIG. 5) and much higher light utilization.

FIG. 7 illustrates another example of this invention. A pair of Fresnel lens (3002 and 3014) forms a see-through waveguide. 3003 and 3004 are incoming light from display and 3012 is an air gap between the pair of Fresnel lens. The incoming light is totally reflected internally (3013) and reaches a surface of Fresnel grooves and totally reflected toward a viewer (3017). 3016 is external scene and external images will be transmitted through this wave guide, so that the viewer can see through the waveguide.

FIG. 8 illustrates an example of this invention. 4001 is a display. 4003 is a light beam from the display to a Fresnel lens. The Fresnel lens has many grooved surfaces and the surfaces are coated with highly reflective material (4008) such as aluminum and silver. The light from the display is reflected (4005) and refracted (4007) by the Fresnel lens material. The refracted light beam (4007) is lead to a waveguide (4011) and totally internally reflected by the surfaces of grooves of Fresnel lens toward a viewer (4012).

FIG. 9 illustrates an example of this invention. 5001 is a display. 5003 is a light beam from the display to a Fresnel lens. The Fresnel lens has many grooved surfaces and the surfaces are coated with highly reflective material (5008) such as aluminum and silver. The light from the display is reflected (5005) and refracted (5007) by the Fresnel lens material. The refracted light beam (5007) is lead to a waveguide (5011) and totally internally reflected by a flat surface of Fresnel lens toward a grooved surfaces (5014). The light is reflected toward a viewer (5012).

FIG. 10 illustrates an example of this invention. 6009 is a reflective display. 6006 is light to illuminate the display. 6007 is reflected light by the display. The reflected light (6007) is reflected by total internal reflection by a flat surface of Fresnel lens (6011). The light is reflected by the grooved surfaces of Fresnel lens (6014) by total internal reflection.

FIG. 11 illustrates an example of this invention. 6009 is a reflective display. 6006 is light to illuminate the display. 6007 is reflected light by the display. If a light beam (6007) enters a Fresnel lens with a non-perpendicular angle, the angle of the entering light beam (6013) will varies by wavelength. This invention illustrates to arrange the angle of entering surface (6018) substantially perpendicular to the light beams (6013) to avoid chroma-aberration.

FIG. 12 illustrates an example of this invention. 7001 is a reflective display. 7006 is light to illuminate the display. 7007 is reflected light by the display. The reflected light (7007) is reflected by an additional mirror (7008) to improve the form factor of this display system.

FIG. 13 illustrates an example of this invention. 8003 is a laser scanning display. 8023 is an optical fiber to input light to this system. 8023 is a focusing lens to focus beam to 8021. 8022 is a scanning mirror to reflect and rotate the direction of deflection. After deflection, the light is focused and create an image (8024) at the location (8020) where the beams have the minimum size of diameter. After the minimum location, the light beam will diverge with a divergent angle of (8025). This image will be projected toward a viewer (8012).

FIG. 14 illustrates an example of this invention. 9005 is an intermediate image created by a display and reflections in the optical path. The light (9009) from 9005 is reflected by the grooved surfaces (9012) toward a viewer (9008). The grooved surfaces (9012) are designed to converge the light beams from the intermediate image toward a viewer and often causes field curvature aberration (9000). This aberration must be corrected at the intermediate image or before to have laser scanning display.

FIG. 15 illustrates an example of this invention. In order to eliminate or reduce the field curvature aberration, the intermediate image (10005) can be adjusted using the reflective surfaces before this intermediate image. The first Fresnel mirror, the first total internal reflection surface can be used to have flat image (10000)

FIG. 16 illustrates an example of this invention. Fresnel grooves (1608) are carved on a curved eye-glass lens (1605) which is used as a light waveguide. Incident light beams (1607) are led into the light waveguide (1605) and the light beams are totally reflected by both the waveguide surfaces (1605 and 1606) and the Fresnel grooves. The reflected light by the Fresnel surface is led toward an eye (1601).

FIG. 17 shows the structure of Fresnel surface at the right side of the circular light waveguide, wherein 1704 is an incident light beam and 1701 is a Fresnel surface to reflect the incident light. 1703 is the envelope of the surface and 1702 is a wall of the grooves.

FIG. 18 shows the middle area and

FIG. 19 shows the left area of the Fresnel surface.

FIG. 20 illustrates an example of this invention, wherein 2002 is the horizontal axis of incident light beam toward an eye-glass with Fresnel surface and 2003 is the vertical axis. The beam has the least vertical width (2004) prior to the least horizontal width (2005) before the eyeglass to compensate the coma and astigmatic aberration of the Fresnel surface.

FIG. 21 shows an example of this invention, wherein 2101 is a display device such as OLED, LCD, LCOS and DMD. The lenses from 2102 through 2104) are relay and projection lenses which lead the light beams into the waveguide. Inside the waveguide, the beams are reflected by a first Fresnel surface (2106) and by a total internal reflection (TIR) surface (2015) and reflected by a second Fresnel surface (2108) toward an eye-center (2109). 2107 is an extrapolated line of the reflected beam which creates a virtual image at a distance.

FIG. 22 shows an enlarged view of the edge of reflected light (2110) of FIG. 21.

### DETAIL DESCRIPTIONS OF THE PREFERRED EMBODIMENTS

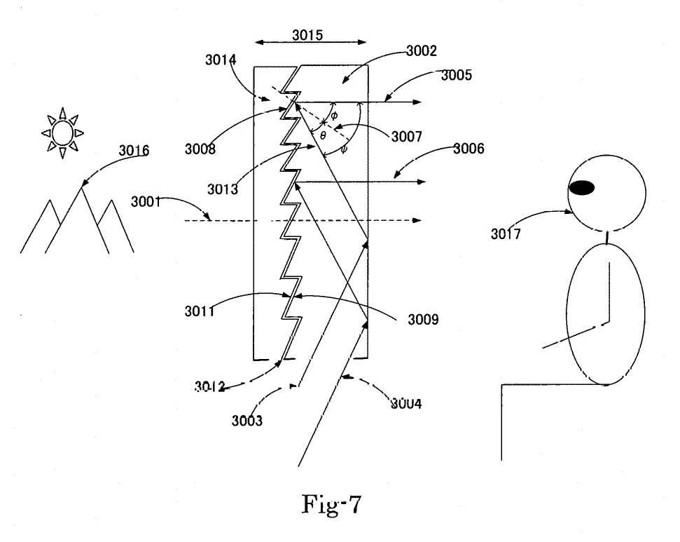

FIG. 5 illustrates an example of embodiment of this invention. A display (1001) of a unit such as a smart phone (1009) is placed in front of a Fresnel mirror element (1015). The light from the display (1001) is emitted in substantially normal direction (1003) with some divergent angle toward mirror surfaces (1008) which are deposited or coated with highly reflective material such as aluminum and silver. The light is reflected by the mirrors (1008) substantially perpendicular direction (1007) from the incoming light (1003). The reflected light (1007) is lead to a waveguide so that the light can be reflected toward viewers at a next optical element. The light entering in the area marked “e” or (1012) will be reflected toward the next waveguide, but the light entering the area marked “d” or (1011) will not reach the waveguide, but will be reflected out of the Fresnel mirror unit (1015) toward the outside (1017) and wasted. The light utilization can be calculated by a formula,

Efficiency=e/(e+d)=tan(π/2−2θ)/(tan(θ)+tan(π/2−2θ))

t=display size/tan(2θ)

As the angle of outgoing light marked “2θ” and (1014) is getting closer to 90°, the efficiency gets worse and becomes almost zero. This example of embodiments is suitable while the thickness of Fresnel mirror unit is not thin. If the thickness, “t” (1016) is 20% of the size of display (1001), the efficiency will be about 20%.

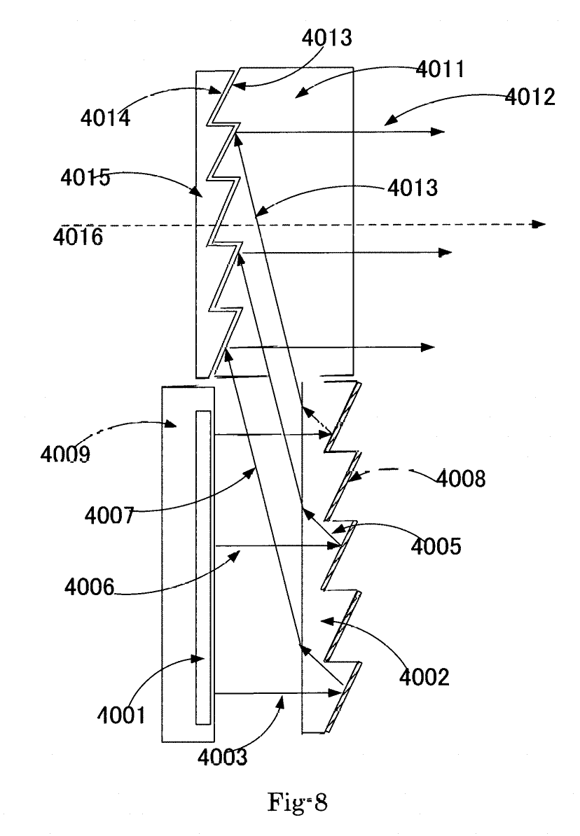

FIG. 6 shows another example of embodiment of this invention. A display (2001) of a unit such as a smart phone (2009) is placed in front of a Fresnel mirror element (2015). The area marked “t” (2016) is a gap filled with air or low refractive index material. The light from the display (2001) is emitted in substantially normal direction (2003) with some divergent angle toward mirror surfaces (2008) which are deposited or coated with highly reflective material such as aluminum and silver. The light is reflected by the mirrors (2008) substantially perpendicular direction (2007) from the incoming light (2003). The reflected light (2007) is lead to a waveguide so that the light can be reflected toward viewers at a next optical element. The light entering in the area marked “e” or (2012) will be reflected toward the next waveguide, but the light entering the area marked “d” or (2011) will not reach the waveguide, but will be reflected out of the Fresnel mirror unit (2015) toward the outside (2017) and wasted. The light utilization can be calculated by a formula,

Efficiency=e/(e+d)=tan(π/2−2θ)/(tan(θ)tan(π/2−2θ))

t=display size/tan(arc sin(n2/n1*sin(2θ)))

φ=arc sin e(n2/n1*sin(2θ))

n2 is the refractive index of Fresnel lens and n1 is that of air (n1=1). As the angle of outgoing light marked “φ” and (2015) is getting closer to 90°, the efficiency converges toward 75% assuming the refractive index of the Fresnel lens unit as n2=1.5. This example of embodiments is suitable when the thickness of Fresnel mirror is very thin. This means that nearly zero thick waveguide can be made with 75% utilization of light. If higher refractive index material is used such as 1.7 to 1.8 that is used for recent eye-glasses, the efficiency can reach 83% even with a waveguide of nearly zero thickness.

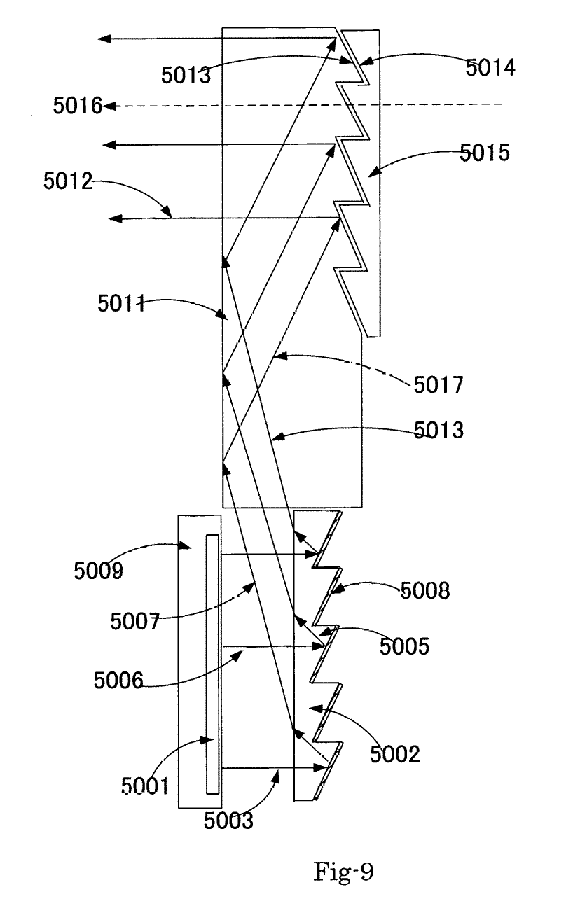

FIG. 7 shows another exemplary embodiment of this invention wherein a waveguide has two Fresnel lenses (3002 and 3014) forming two independent functions of 1) see-through transparent flat plate and 2) total internal reflection (TIR) mirror reflecting the light lead from a Fresnel mirror unit as illustrated in FIG. 5 and FIG. 6. The dotted line (3007) is the normal direction of the surface of Fresnel lens and (3012) is an air gap between two Fresnel lenses wherein the refractive index is substantially lower than those of Fresnel lenses, so that total internal reflection will take place, if the following condition is met. The angle marked “φ” is the tilt angle of groove surface of the Fresnel mirror. The angle, marked as “θ”, is between the normal direction (3007) and the incident light (3013) and n2 is the refractive index of the Fresnel lenses and the refractive index of the gap between the two Fresnel lenses is n1. The two surfaces of the Fresnel lenses (3009 and 3011) should be parallel and the gap should be close to zero so that the light from outside (3001) goes through the waveguide without deflection.

θ>arc sin e(n1/n2)>φ

ψ=θ+φ>2*arc sin e(n1/n2)

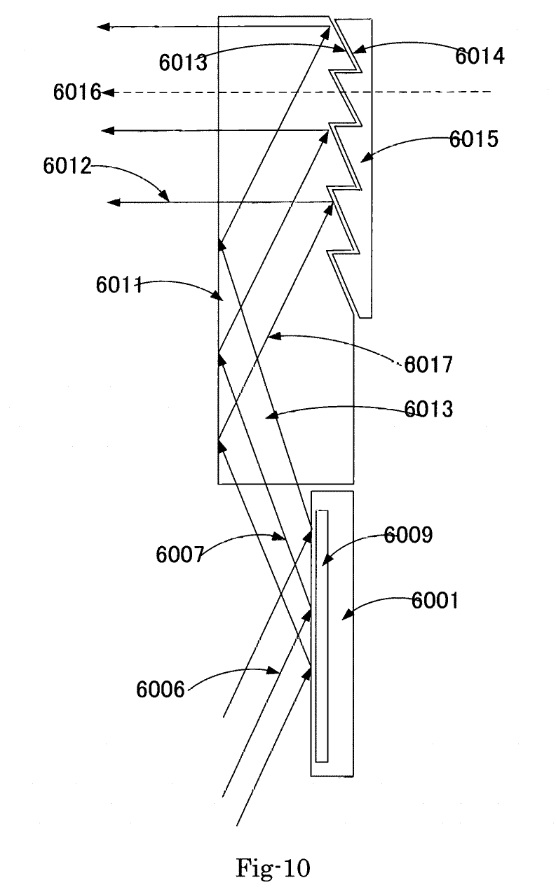

FIG. 8 shows another exemplary embodiment of this invention, wherein a Fresnel mirror described in FIG. 6 and a waveguide described in FIG. 7 are combined to form a thin see-through display using an ordinary display such as that of smart phone. The light utilization can reach over 75% ignoring the loss at the edges of the mirrors and the reflectance loss of mirror surface. The transmission of external light (4016) can be very high and the loss is only surface reflection which is about 4% at each surface with AR coating and less than 0.3% at each surface with practical anti-reflective (AR) coating. Therefore over 80% of transmission without AR and over 98% with AR are possible.

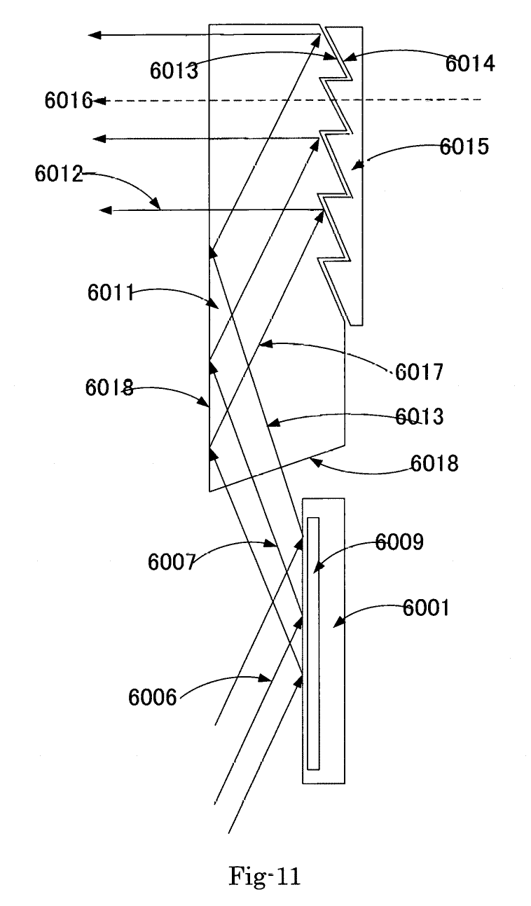

FIG. 9 shows another exemplary embodiment of this invention, wherein the light inside the waveguide is totally reflected at least once (5013 and 5017), so that the waveguide can be extended without the loss of light.

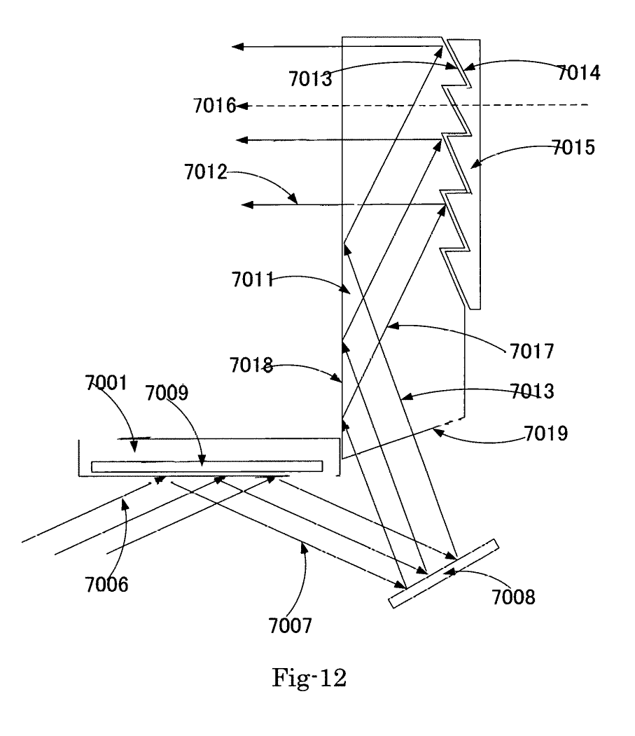

FIG. 10 shows another exemplary embodiment of this invention, wherein a reflective display is used and the incident light (6006) and outgoing light (6007) are substantially away from the normal direction of the surface of display and lead into a waveguide (6013). This does not require the first Fresnel mirror unit as in FIG. 9.

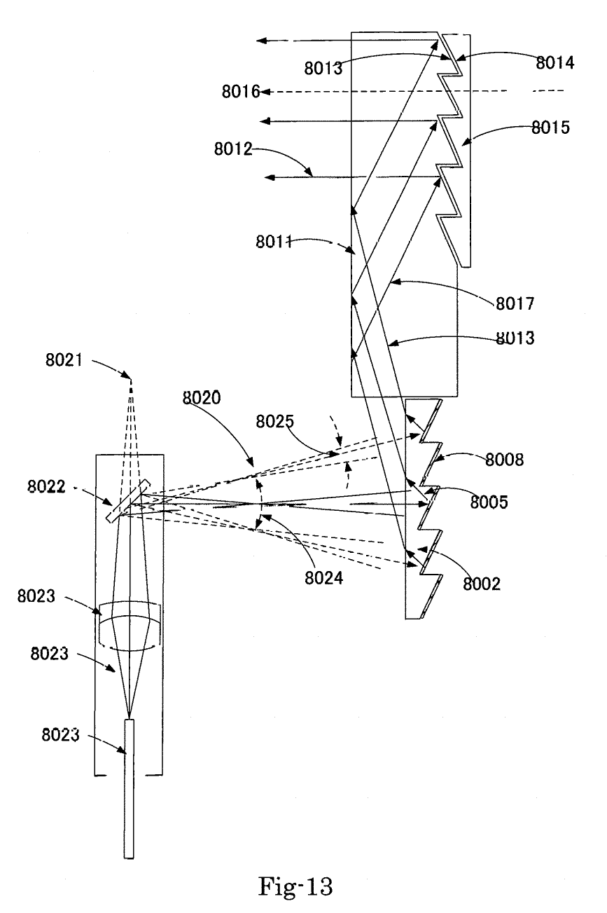

FIG. 11 shows another exemplary embodiment of this invention, wherein the entrance surface (6018) of a waveguide is substantially perpendicular direction to the incident light (6013) so that the chromatic aberration caused by the entry angle of each color is minimized.

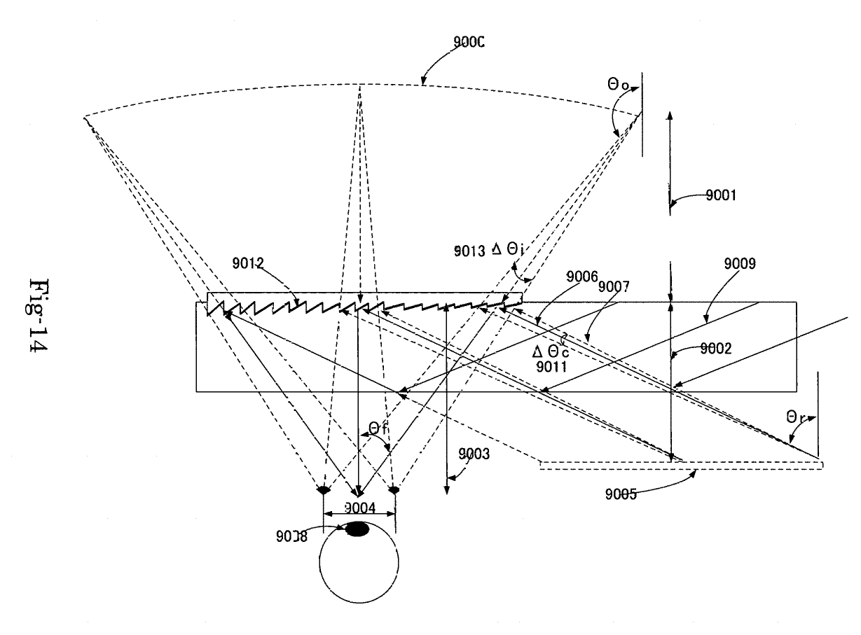

FIG. 12 shows another exemplary embodiment of this invention, wherein a reflective display (7009) is used and the outgoing light (7007) is substantially away from the normal direction of display surface and reflected at least a mirror (7008) before entering a waveguide (7019).

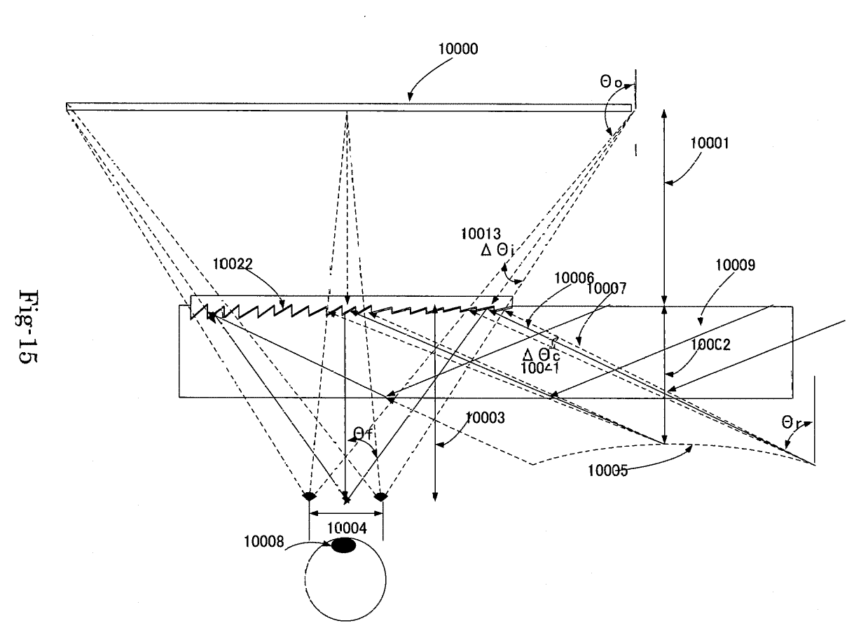

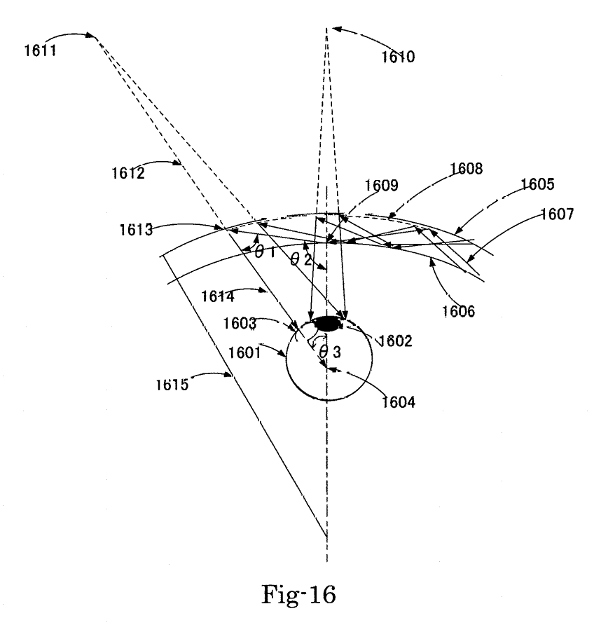

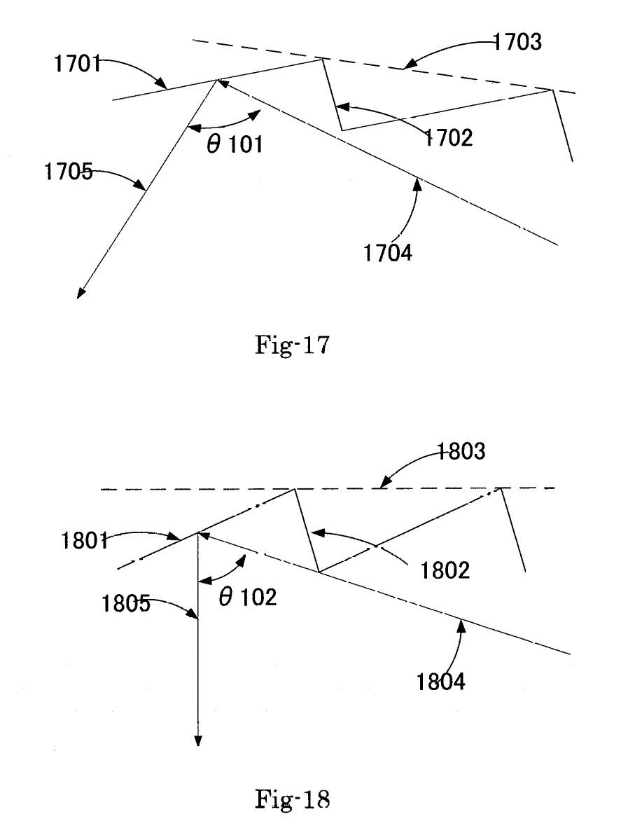

FIG. 13 shows another exemplary embodiment of this invention, wherein a laser beam scanning device (8022) is used as a display and the light beam of the scanner is focused into a minimum spot (8021) so that it will diverge toward a viewer and the viewer can have a large eye-box (9004 in FIG. 14 and 10004 in FIG. 15, eye-box is defined as the size where a viewer can see image). The size of eye-box is proportional to the divergent angle (8025) of light beam. A real image (8024) is formed at (8020) and the image can be enlarged by Fresnel mirrors (8008) with varying tilt angles and curved reflective surface (8011) and Fresnel mirrors (8013) with varying tilt angles forming convex or concave curvature. The location of a virtual image can be adjusted by varying the curvature of these reflective surfaces.

FIG. 14 shows another exemplary embodiment of this invention, wherein an image (9005) created by reflection of the image of a display. This image (9005) has divergent light beams (9006 and 9007) from each pixel of the display. This divergent beam (9007 and 9008) is reflected by a Fresnel mirror (9012) and reaches a viewer's eye (9008) with a width of beam (9004). The image (9005) is projected to a virtual image (9000). As long as the viewer's eye (9008) is within the width (9004), the viewer can see the image. The curvature of the Fresnel lens is designed so that virtual image (9000) is focused to the viewer's eye (9008), this designed lens curvature often causes large field curvature aberration as the non-flat image of (9000).

FIG. 15 shows another exemplary embodiment of this invention. The field curvature aberration as shown in FIG. 14 cannot be corrected by the Fresnel mirror of (9012) and has to be corrected at a prior stage as shown in FIG. 15. The image (10005) is an image of display prior to the Fresnel mirror (10022) and has to be corrected so that a flat image (10000) will be created. As shown in FIGS. 8, 10 and 11, there one reflecting surface prior to the final Fresnel mirror and as shown in FIGS. 9, 12, and 13, there are two reflecting surfaces. These surfaces can have curvature to correct the image shape (10004) so that the field curvature (9000) in FIG. 14 will be corrected as (10000) in FIG. 15.

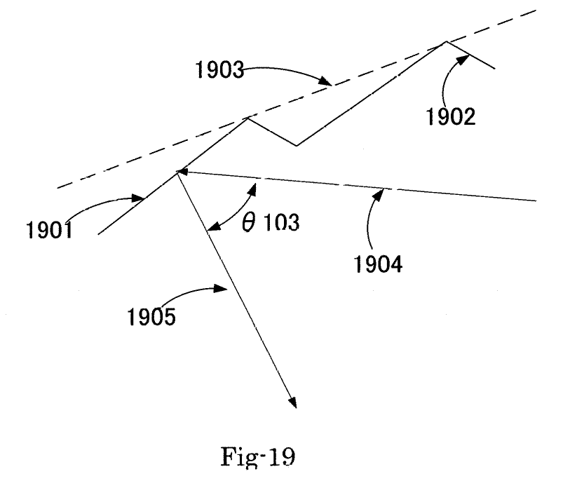

FIG. 16 shows another exemplary embodiment of this invention. Light beams containing an image (1607) are led into a curved light waveguide (1605) and the beams are reflected internally by total internal reflection (TIR) to a Fresnel surface (1608) where the beams are reflected to an eye (1601). The angle marked as (θ1) is the reflection angle at the Fresnel surface which has to be larger than 2*arc sin(1/n) for TIR, where n is the refractive index of the eye-lens. A curved surface helps to increase the field of view (FOV) shown as an angle shown as θ3. In recent years, some plastic materials with very high refractive index are developed and used for eyeglass lenses which are much thinner than before to create same lens-power. Because of these materials and a curved surface, the FOV of embodiments of this invention can be made as high as 60 degrees with a TIR condition. In other words, this invention enables a see-through display with high FOV and high resolution without hologram or DOE which requires a laser light source. A simple OLED or SLM (spatial light modulator as LCD and DMD) with LED sources will become usable with this invention.

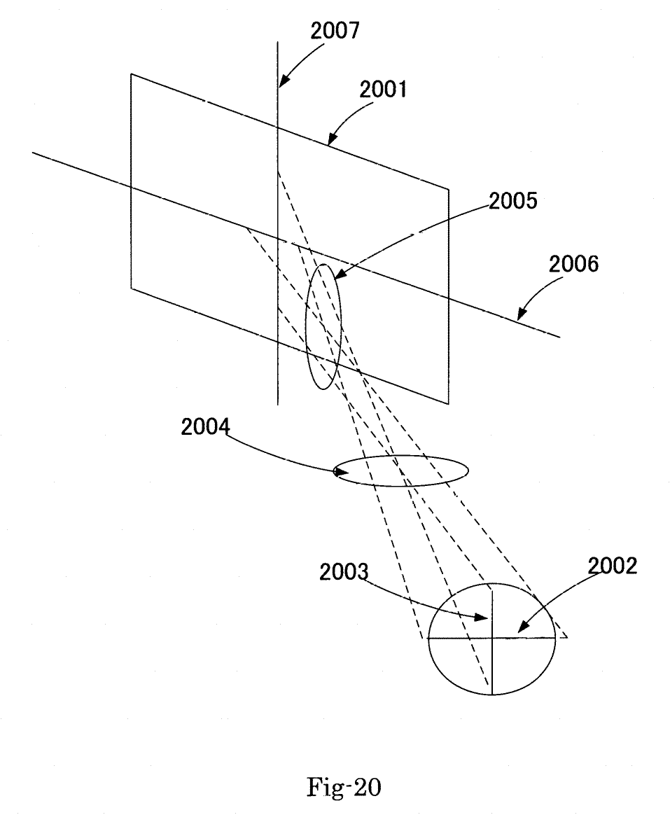

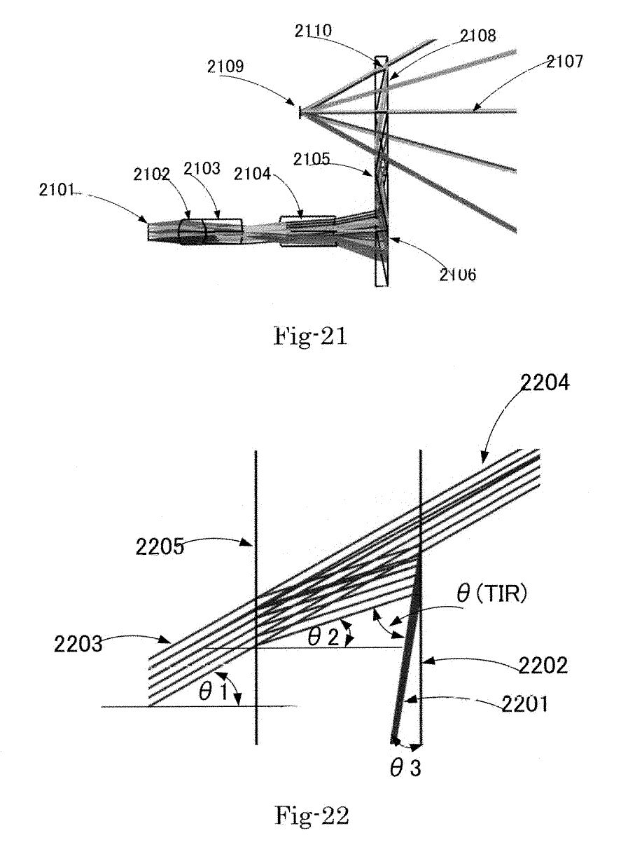

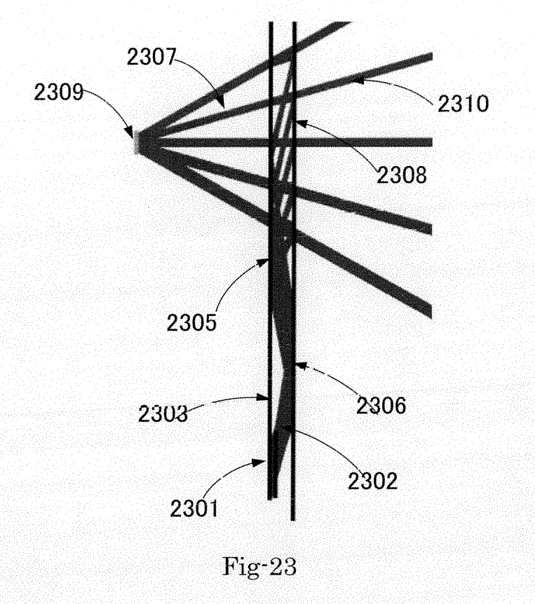

As shown in FIGS. 17, 18 and 19, the reflection angle defined as the angle between incident beam and reflected beam determines if the beam will be reflected by TIR or pass through unless reflective material is coated. At the most left side of FOV, the reflection angle becomes smallest and if θ103 is lower than TIR angle (2*arc sin(1/n)), the beam will not be reflected but passed through.

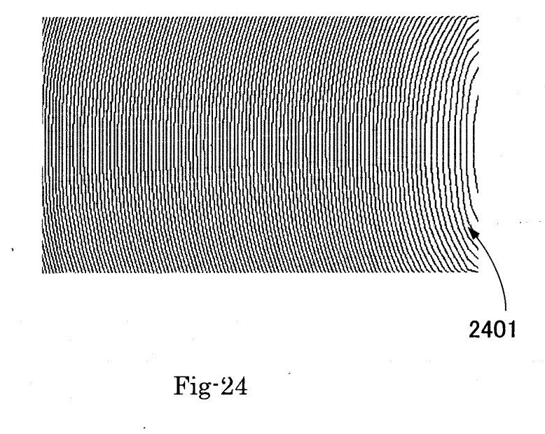

FIG. 20 illustrates an example of this invention, wherein 2002 is the horizontal axis of incident light beam toward an eye-glass with Fresnel surface and 2003 is the vertical axis. A Fresnel mirror on the eye-lens bends the light beams substantially in only horizontal direction and not in vertical direction, which creates large astigmatic and coma aberrations. These aberrations must be compensated prior to the Fresnel mirror, because it is the final step to a viewer's eye. The incident beams having the least vertical width (2004) prior to the least horizontal width (2005) as shown in FIG. 20 can compensate the astigmatic and coma aberrations.

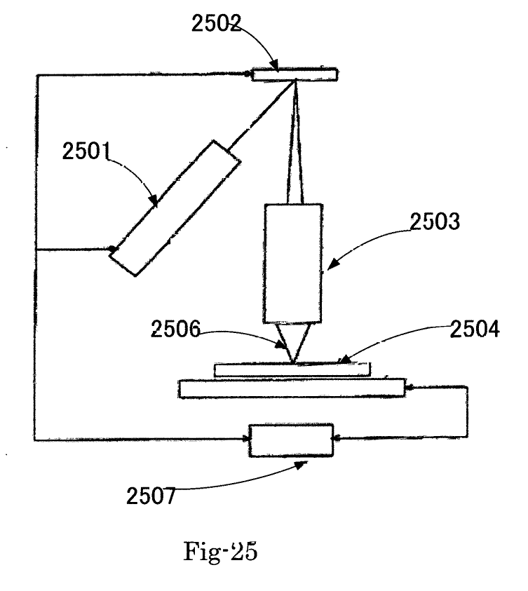

FIG. 21 shows another example of embodiments of this invention. A display device (2101) such as OLED, LED, LCOS and DMD emits light toward a relay lens (2102 and 2103) and a projection lens (2104). The relay lenses and the projection lens are free-form-surface lenses. Because of non-symmetry of the optical system, some free-form-surface lenses are necessary. This example indicated high resolution and large FOV can be achieved by Fresnel mirror.

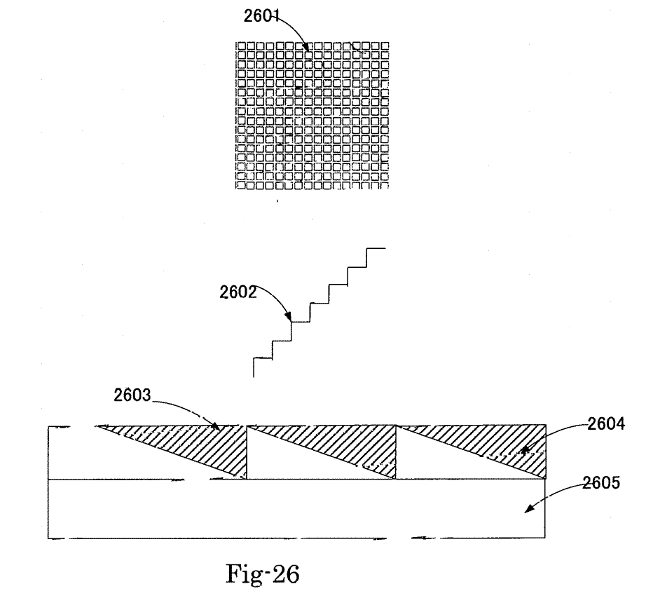

FIG. 22 shows another example of embodiments of this invention. θ1 is the FOV angle. A large FOV is very desirable. FIG. 22 is an enlarged figure of 2110 in FIG. 21. θ3 is the angle of incident beam from the surface of Fresnel (2202). 2204 is a line extrapolated from the final beam to an eye (2203). θ2 is the reflection angle as defined in the previous section of this application and θ2>TIR angle for total internal reflection.

FIG. 23 shows an example of embodiments of this invention. A display device (2301) emits light in a tilted direction into a waveguide (2303). The emitted light is reflected by a first free-form surface mirror or Free-From-Fresnel mirror at (2306) and by a second free-form surface mirror (2305) before reflected by a final Free-From-Fresnel mirror (2308) toward an eye center (2309) creating a virtual image along 2310 which is an extrapolated line from the reflected line (2307).

FIG. 24 shows an example of embodiments of this invention. The figure shows a map of equi-slope lines of the slope of groove surface of Free-Form-Fresnel lens. Each line is connecting the locations of same slope angle. As shown in this figure, the slope varies by location and not necessarily straight nor symmetric and must be generated to meet an optical lens requirement.

A manufacturing method to create such a free-form-slope requires a new novel process. An existing technique is to cut grooves by CNC (computer numerical control machining), however it requires many weeks to operate continuously, because the pitch of grooves is very minute and often below 100μ for a head-up display and even much lower for eyeglass display. This invention discloses a novel method using optical exposure which is substantially faster and often over thousand times faster. Weeks will be an hour.

FIG. 25 shows an example of embodiment of this invention. 2502 is an array of pixels, or 2D spatial light modulator (SLM) and incoming light (2501) is spatially modulated and projected by a lens system (2503) to a substrate (2504) coated with photoresist and the photo-resist is exposed with a light beam (2506).

FIG. 26 shows an example of embodiment of this invention. 2601 is an array of pixels and the brightness of each pixel can controlled by a controller (2507). 2602 is an example of the intensity distribution of projected image. The array of pixels can be a digital micro-mirror-device (DMD), a LCOS or any other SLM, which can control the brightness distribution. 2603 is the exposed area and depth. The area where the exposure exceeds a threshold energy level of photoresist is marked as 2603. The depth of penetration of exposure light is exponentially proportional to the intensity and the depth of exposure can be controlled by a controller. If negative photoresist is used, the area with shadow lines will be removed by a development process, because the exposed area becomes soluble. After development, saw-tooth shaped grooves will be made which represents Fresnel mirror or lens. The pattern can be copied to a metal mold using electro-plating process. Then Fresnel lenses and mirrors can be manufactured with UV casting or thermal forming process.

I claim:

1. An optical waveguide comprising:
A waveguide made of a transparent plate and
A Display and
A Fresnel lens made of a transparent material having a first flat surface and a second surface whereon micro-ridges as saw-tooth are carved and have flat sloped minute surfaces whose slope angle is a free form function and
Light beams projected from said display entering substantially perpendicular to the first flat surface of said Fresnel lens wherein
Said light beams are reflected by the sloped surfaces on the second surface back to the first flat surface and the refractive index of the Fresnel lens of n2, the media adjacent to the first flat surface of n1, the reflecting angle at the sloped surface defined as the angle between the incident beam and the reflected beam of θ and the angle between the outgoing beam from the first surface and the normal direction of the first flat surface of φ satisfies the condition below:
φ=Arc sin e(n2/n1*sin(2θ))>π/3(60°)

2. The optical waveguide of claim 1 wherein:
The display is from a group of OLED, LCOS, LCD, Laser-Beam-Scanner, Micro-mirror and Micro-shutter.

3. An optical waveguide comprising
A display projecting image light beams and
A pair of complimentary Fresnel lenses having saw-tooth shaped micro-ridges whose slope angle is a free form function and the slopes of the surfaces of two complimentary Fresnel lenses are parallel and the gap between said pair of complimentary Fresnel lenses is less than 1 mm wherein
The image light beams of said display are projected into one of the Fresnel lens and the angle of a surface of ridge is φ and the angle between the incident light beam and the normal direction of the surface of ridge is θ and the refractive index of the Fresnel lens is n2 and the refractive index of the gap is n1 and the condition below is satisfied to pass the external light coming from outside scene through the pair of Fresnel lenses, although the internal light coming from the display is reflected toward a viewer:
θ>arc sin e(n1/n2)>φ

4. The optical waveguide of claim 3 wherein:
The slope of saw-tooth shaped ridge of the Fresnel lens is a slope of free-form-surface and the reflecting angle ψ (=θ+φ of the previous claim) defined as the angle between an incident light beam and its reflected beam satisfies the following formula so that the incident beams are reflected by total internal reflection:
ψ>2*arc sin e(n1/n2)
n2 is the refractive index of waveguide of Fresnel lens.
n1 is the refractive index of the gap between complimentary Fresnel grooves.

5. The optical waveguide of claim 3 wherein:
The display emits beams substantially away from the normal direction of its pixel array and the projected beams are through at least one lens with a free-form surface before entering the waveguide and the beams are crossed, so that real images are formed before the Fresnel micro-ridges.

6. The optical waveguide of claim 5 wherein:
The location of horizontally minimum width of the real images differs from the location of vertically minimum width and the location of horizontally minimum width is closer to the Fresnel micro-ridges than that of vertically minimum width to minimize Astigmatic and Coma aberrations.

7. The optical waveguide of claim 6 wherein:
The Fresnel lens forming the waveguide is curved.

8. A manufacturing method having the steps of:
Calculating a pattern of slopes of the surfaces of ridges of Free-Form-Fresnel lens/mirror and
Preparing a exposure system capable to expose photoresist with a 2D spatial light modulator having grayscale and
Preparing a substrate coated with photoresist and
Exposing the photoresist with the intensity of the calculated pattern and
Developing the exposed photoresist to make saw-tooth shaped ridges and
Copying the shape of photoresist to a mold made of harder material
Duplicating the shape from the mold to a plastic material by a method from a group of thermal press, UV casting, roll-to-roll thermal imprint and roll-to-roll UV casting.

9. The manufacturing method of claim 8 wherein:
The spatial light modulator is from a group of LOCS, LCD, Micro-mirror and Micro-shutter.

10. The manufacturing method of claim 8 wherein:
The substrate coated with photoresist is a roller and the exposure system has a phase-lock-loop to synchronize the rotation of roller and the exposure timing.
